(19) United States
(12) Patent Application Publication
(10) Pub. No.: US 2002/0048503 A1
(43) Pub. Date: Apr. 25, 2002

(54) Carrying system

(75) Inventor: Masazumi Fukushima, Aichi (JP)

Correspondence Address: ARMSTRONG,WESTERMAN & HATTORI, LLP, 1725 K STREET, NW., SUITE 1000, WASHINGTON, DC, 20006, US

(73) Assignee: Murata Kikai Kabushiki Kaisha, Kyoto-shi (JP)

(21) Appl. No.: 09/876,079

(22) Filed: Jun. 8, 2001

(30) Foreign Application Priority Data
Jul. 4, 2000 (JP) 2000-201787

(51) Int. Cl. B65G 1/00

(52) U.S. Cl. 414/266

(57) ABSTRACT

An auxiliary cart 20 is provided to back up a stacker crane in a process, and normally stands by in a passage 12. In operation, a manual cart 22 is loaded on the auxiliary cart 20, and the auxiliary cart 20 is controlled from the manual cart 22 to load and carry articles within the process. Therefore, if the stacker crane in the process fails, it can be backed up by loading the manual cart on the auxiliary cart to move them into the process.

### FIELD OF THE INVENTION

The present invention relates to backup of a main carrying device in a carrying system for use in semiconductor or liquid crystal factories.

### BACKGROUND OF THE INVENTION

In a known carrying system for use in a semiconductor factory, liquid crystal factory, or the like, stockers or the like are additionally arranged in a row of processing devices for one process so that a carrying device such as a stacker crane can carry articles between these devices, while another carrying device such as an overhead running cart or a tracked cart can carry the articles between processes. If the stacker crane fails, that process is halted, affecting the entire factory.

It is an object of the present invention to use an auxiliary cart of a simple configuration and a running rail of a main carrying device to back up the main carrying device when it fails, while preventing the auxiliary cart from obstructing the main carrying device.

It is another object of the present invention to provide a specific configuration for the auxiliary cart and a loaded cart.

It is yet another object of the present invention to enable a manual cart to be loaded on and unloaded from the auxiliary cart on the passage of the manual cart and to make it possible to control the auxiliary cart from the manual cart.

### SUMMARY OF THE INVENTION

The present invention provides a carrying system having an auxiliary cart that normally stands by outside a running range of a main carrying device and along a running rail of the main carrying device and that runs along the running rail with a loaded cart carried thereon when the main carrying device must be backed up.

Preferably, the loaded cart is manually controlled, and the auxiliary cart stands by under a floor of a passage of the manual cart, and the running rail is laid at least up to the standby position of the auxiliary cart under the floor of the passage.

Particularly preferably, a height of a loading surface of the manual cart on the auxiliary cart is substantially the same as a height of the floor of the passage, and connectors for transmitting a control signal from the manual cart to the auxiliary cart are provided so as to be freely connected to and disconnected from each other on the passage.

According to the present invention, when the main carrying device must be backed up, the auxiliary cart runs along the running rail of the main carrying device with the loaded cart carried thereon. The auxiliary cart normally stands by outside the running range of the main carrying device. Thus, the main carrying device can be backed up upon a failure. Furthermore, the running rail of the main carrying device can be shared with the auxiliary cart, and the auxiliary cart is normally prevented from obstructing the main carrying device. Additionally, during backup, the auxiliary cart carries the loaded cart thereon, thus eliminating the needs for a loading device or the like in the auxiliary cart to allow the auxiliary cart to be simply configured.

Moreover, the loaded cart is manually controlled, and the running rail is extended up to a location under the floor of the passage of the manual cart, where the auxiliary cart stands by. This eliminate the needs for an extra space in which the auxiliary cart stands by. For backup, the manual cart is loaded on the auxiliary cart, so that the backup operation can be easily performed under the manual control. After the manual cart has been unloaded from the auxiliary cart, it can be used to carry articles.

Furthermore, the height of the loading surface of the manual cart on the auxiliary cart is substantially the same as the height of the floor of the passage, and the connectors for transmitting a control signal from the manual cart to the auxiliary cart are provided so as to be freely connected to and disconnected from each other on the passage. Thus, the connectors can be connected together on the passage of the manual cart so that the auxiliary cart can be controlled from the manual cart so as to load the manual cart thereon on the passage of the manual cart. Further, the manual cart can be disconnected from the auxiliary cart on the passage of the manual cart.

### BRIEF DESCRIPTION OF THE DRAWINGS

FIG. 1 is a top view showing a layout of a carrying system according to an embodiment.

FIG. 2 is a perspective view showing a manual cart and an auxiliary cart both placed in font of a door, according to the embodiment.

FIG. 3 is a view showing that the auxiliary cart with the manual cart carried thereon is moved into a process through the door, according to the embodiment.

FIG. 4 is a view showing the manual cart on the auxiliary cart in the process.

FIG. 5 is a view showing that the auxiliary cart and the manual cart standing by in the passage.

FIG. 6 is a top view showing a layout of a second variation.

### DETAILED DESCRIPTION OF THE PREFERRED EMBODIMENTS

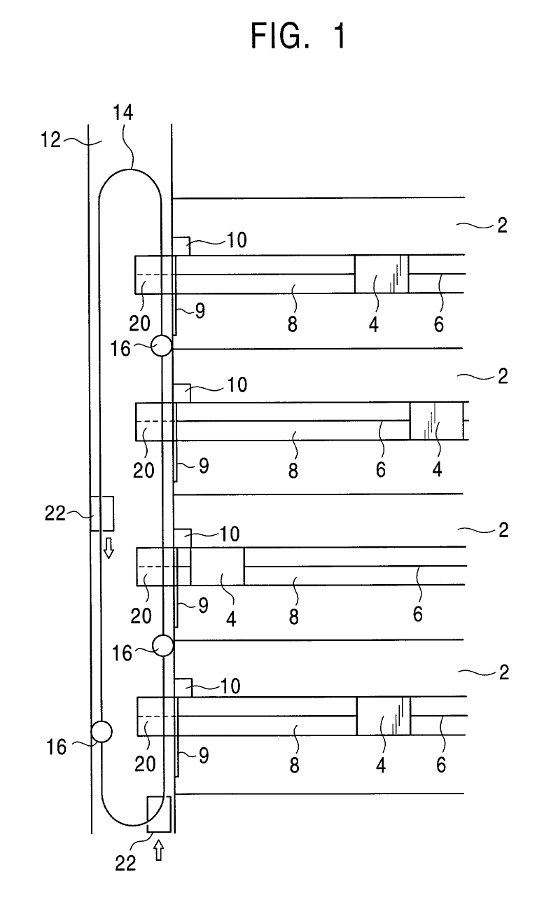

FIGS. 1 to 4 show an embodiment. FIG. 1 shows the entire configuration of a carrying system according to the embodiment. 2 is a definite process of manufacturing semiconductors, liquid crystal panels, medical supplies, or the like. Each process includes various processing devices arranged therein as well as stockers or shelves of an automatic warehouse in or on which unfinished articles are stored. 4 is a stacker crane used as a main carrying device for carrying unfinished articles within the process 2. Carrying devices other than the stacker crane may be used as the main carrying device. 6 is a running rail, 8 is a running space for the stacker crane, and 9 is a door to the process 2. Additionally, 10 is a loading station at which articles are loaded on an overhead running cart, described later, the loading station being provided at a height level near the ceiling.

12 is a passage facing the processes 2, 14 is a track of the ceiling running cart, and 16 is the ceiling running cart which delivers and receives articles to and from the stacker crane 4 via the loading station 10. Thus, in the embodiment, the stacker crane 4 carries articles within the process, while the overhead running cart 16 carries articles between the processes. Although FIG. 1 shows the processes 2 and others only to the right of the passage 12, the processes 2 and others may also be arranged to the left of the passage 12. Further, the processes 2, the passage 12 and others are arranged in a clean room, and the doors 9 are used in order to set the cleanliness of the process 2 side higher than that of the passage 12 side to thereby prevent dust from the passage 12 side from entering the process 2 side.

20 is a simple auxiliary cart which can run along the running rail 6 but which does not include a loading device or an elevating device. The auxiliary cart 20 normally stands by outside the running range of the stacker crane 4, for example, in the passage 12 as shown in FIG. 1. 22 is a manual cart that may be a pushcart manually pushed to move on the passage 12 or a power cart comprising a steering handle and the like, a battery, and a running motor. In the future, the manual cart 22 may include a CCD camera or the like to take photographs of surrounding views and transfer the obtained images to a control room where the motion of the manual cart can be manually controlled.

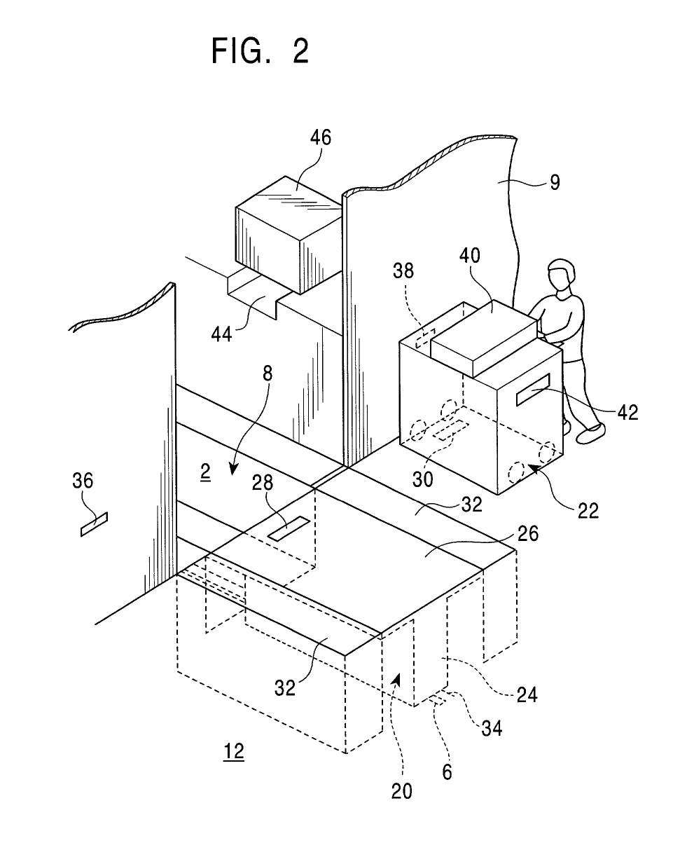

FIG. 2 shows the relationship between the auxiliary cart 20 and the manual cart 22. The auxiliary cart 20 includes a running section 24 having the running motor, wheels, and the like. The auxiliary cart 20 has a plate-shaped loading section 26 placed at its top and grated in the same manner as the floor of the surrounding passage 12 in order to obtain an air current from the space in the passage 12 to under the floor. The top surface of the loading section 26 of is set at the same height as the floor surface of the surrounding passage 12, and the running rail 6 is laid at a position lower than the floor surface. 28 is a connector of the auxiliary cart 20, and 30 is a connector of the manual cart 22. When the connectors 28, 30 are connected together, power can be supplied from the auxiliary cart 20 to the manual cart 22, and the auxiliary cart 20 can be steered from the manual cart 22 side.

32, 32 are safety fence storing sections located on both sides of the standby position of the auxiliary cart 20. When the manual cart 22 is loaded on the auxiliary cart 20, which is then pushed into the process 2, a slot is left in the passage 12. Thus, the safety shelf storing sections store safety fences for preventing an operator from falling in the slot. Further, 34 is a trolley line arranged in parallel with the running rail 6 and used to feed power to the stacker crane 4 and the auxiliary cart 20. 36 is a fixed coupler, and 38 is a coupler provided on the manual cart 22. When the couplers 36, 38 are coupled together, power can be fed to the manual cart 22 from locations other than that of the auxiliary cart 20, and a loading device 40 such as a slide fork can be driven. 42 is a control panel that is used to control the loading device 40 and to steer the auxiliary cart 20 when the connectors 28, 30 are connected together. 44 is a recess portion formed in the station in the process 2 and on which an article 46 is placed.

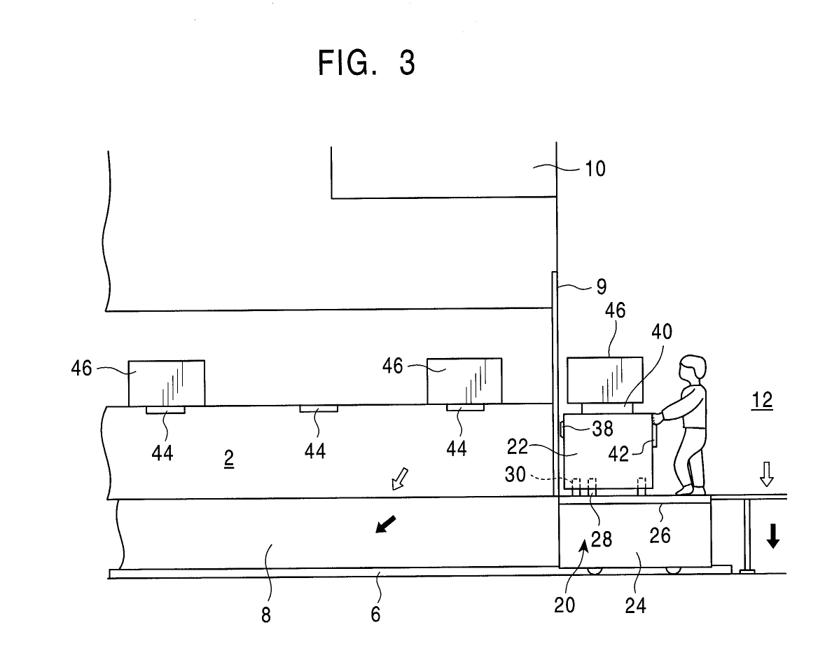

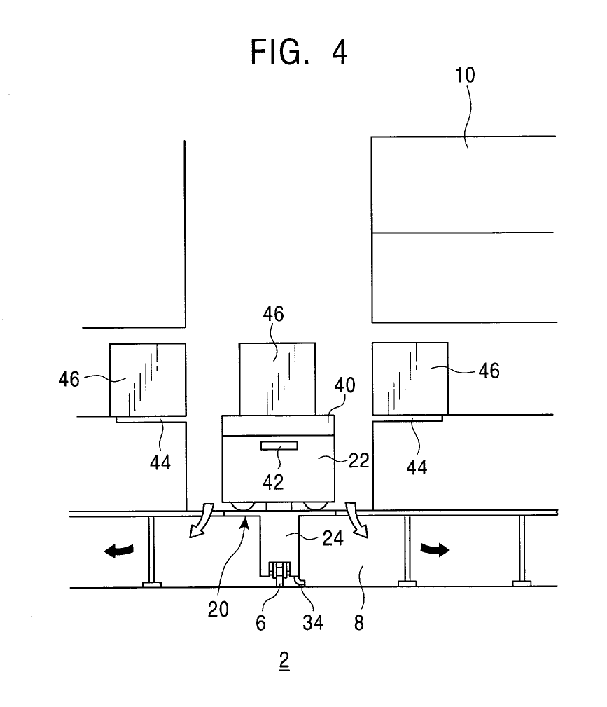

FIGS. 3 and 4 show how the manual cart 22 is loaded on the auxiliary cart 20 (FIG. 3) and how they run within the running space 8 (FIG. 4). The loading section 26 of the auxiliary cart 20 is at the same height as the floor surface of the passage 12 so that, for example, the manual cart 22, pushed manually, can be naturally slid on the loading section 26. When the connectors 28, 30 are connected together, the auxiliary cart 20 and the manual cart 22 are mechanically connected together, and the auxiliary cart 20 can be steered from the control panel 42. A wheel stop may further be provided on the loading section to position the manual cart 22 on the loading section 26. Once the manual cart 22 is loaded on the auxiliary cart 20, the auxiliary cart 20 is controlled from the control panel 42 so as to enter the process 2 and use the loading device 40 to insert a fork into the recess portion 44 to thereby load the article 46.

A space where an operator can sit for steering is preferably formed in the auxiliary cart 20 or the manual cart 22. With respect to an air current in the clean room, as shown in FIGS. 3 and 4, clean air (shown by the white arrow in the figures) flows through the grating in the floor or the loading section 26 and is sucked from under the floor as shown by the black arrow in the figures. When the auxiliary cart 20 enters the process, since a slot is left in the passage 12 after the auxiliary cart 20 has been moved, the safety fences are removed from the safety fence storing sections 32, 32 and then set.

Then, if trouble occurs in the stacker crane 4, the auxiliary cart 20 can be used to continue carrying and loading articles only if the stacker crane 4 can be moved backward to a location where it does not interfere with the auxiliary cart 20. Thus, the relevant process need not be stopped, and the delay in production by the entire factory can be minimized. Further, since the auxiliary cart 20 has a configuration simple enough to run on the running rail 6 and does not require a loading device or an elating device, it can be installed easily. The auxiliary cart 20 can run using the running rail 6 and the running space 8 for the stacker crane 4.

Within the process 2, the auxiliary cart 20 can be steered from the manual cart 22, and the loading device 40 of the manual cart 22 can be directly used to load the article 46. Since the auxiliary cart 20 is used for a backup operation in an emergency, it is preferable that an operator ride on and steer the auxiliary cart 20 and manually control the loading device 40. After the auxiliary cart 20 has returned to the passage 12 from the process 2, the connectors 28, 30 can be disconnected from each other, and the manual cart 22 can be moved along the passage 12. Thus, the same manual cart 22 can be used to carry articles to the next process.

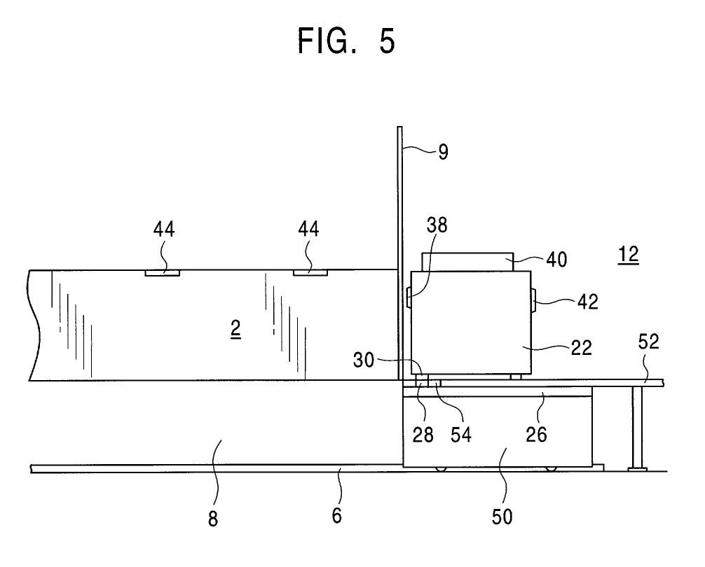

FIG. 5 shows a variation. In the embodiment in FIGS. 1 to 4, since the loading section 26 of the auxiliary cart 20 is at the same height as the floor surface of the passage 12, a cover covering the loading section 26 cannot be provided in the passage 12, so that a slot is left in the passage 12 after the auxiliary cart 20 has been moved into the process 2. Thus, in the variation in FIG. 5, the top surface of the loading section 26 is set slightly lower than the bottom surface of a grating floor 52 in the passage 12. Then, a hole 54 that is open toward to the running space 8 is formed around the connector 28 so that the connector 28 can be connected to the connector 30 of the manual cart 22. This variation is similar to the embodiment in FIGS. 1 to 4 except for specifically noted points.

In the variation in FIG. 5, the manual cart 22, which has been moved through the passage 12 manually or by other means, is stopped over the auxiliary cart 50 hidden under the grating floor 52, and the connectors 28, 30 are then connected together. In this state, when the auxiliary cart 50 is started using the control panel 42, the manual cart 22 is towed by the auxiliary cart 20 via the connectors 28, 30 and is loaded onto the auxiliary cart 20. Although the hole 54 is left in the passage 12 side as an opening, no other large hole is left therein.

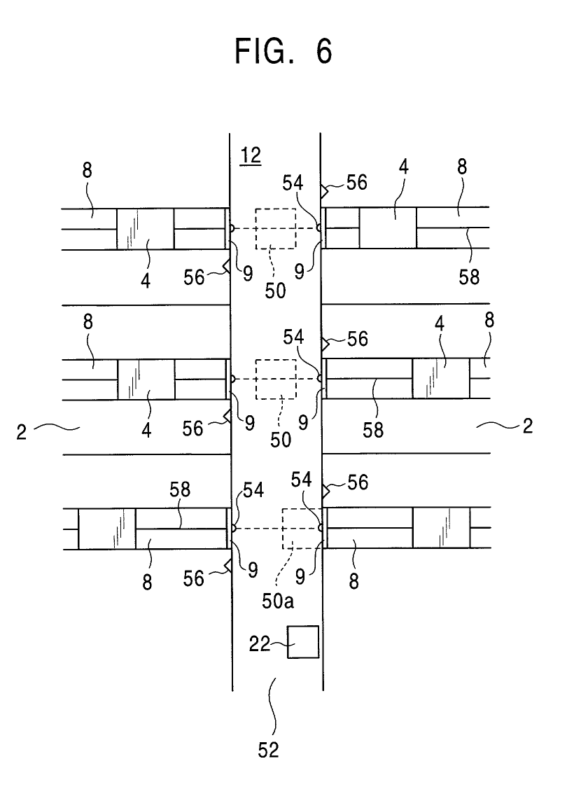

FIG. 6 shows a second variation. In the embodiment in FIGS. 1 to 4 and the variation in FIG. 5, the auxiliary carts are provided so as to correspond to the processes on a one-to-one basis, and stand by immediately outside the door 9. In contrast, in the variation in FIG. 6, an auxiliary cart 50 stands by under the floor of a central portion of the passage 12, and a running rail 58 of the stacker crane 4 is correspondingly extended to penetrate the passage 12. The above holes 54 are formed near the respective ends of the passage 12, and a cart-getting switch 56 is used to provide an input determining whether to move the auxiliary cart 50 to the right or left of the passage 12. In the variation in FIG. 6, if in any of the processes, trouble occurs in the stacker crane 4, the cart-getting switch 56 is depressed to move an auxiliary cart 50a to this process, and the connector 28 is exposed from the hole 54 and connected to the connector of the manual cart 22. Subsequently, the loading and conveyance of articles and other operations within the process are performed in the same manner as in the variation in FIG. 5.

In the embodiment and the variations, the manual cart 22 is loaded on the auxiliary carts 20, 50 on the passage 12, but the present invention is not limited to this. For example, if trouble occurs in the stacker crane 4, the auxiliary cart may be moved to the passage-12-side end of the running space 8 in the process, and the manual cart 22 may then be manually pushed to pass through the door 9 and then slide onto the auxiliary cart in the running space 8. In this case, however, the direction of the manual cart 22 must be changed rapidly, possibly causing dust and making the operation cumbersome.

1. A carrying system characterized by having an auxiliary cart that normally stands by outside a running range of a main carrying device and along a running rail of said main carrying device and that runs along said running rail with a loaded cart carried thereon when the main carrying device must be backed up.

2. A carrying system according to claim 1, characterized in that said loaded cart is manually controlled, and said auxiliary cart stands by under a floor of a passage of said manual cart, and said running rail is laid at least up to the standby position of the auxiliary cart under the floor of said passage.

3. A carrying system according to claim 2, characterized in that a height of a loading surface of said manual cart on said auxiliary cart is substantially the same as a height of the floor of said passage, and connectors for transmitting a control signal from said manual cart to said auxiliary cart are provided so as to be freely connected to and disconnected from each other on said passage.
